(19) United States
(12) Patent Application Publication
(10) Pub. No.: US 2006/0204215 A1
(43) Pub. Date: Sep. 14, 2006

(54) Method and apparatus for data retrieval

(75) Inventor: Willem Peter Van Der Brug, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 10/567,273

(22) PCT Filed: Mar. 31, 2004
(86) PCT No.: PCT/IB04/50373

§ 371 Date: Feb. 6, 2006

(30) Foreign Application Priority Data
Apr. 10, 2003 (EP) 031009731

(51) Int. Cl. H04N 5/91

(52) U.S. Cl. 386/68

(57) ABSTRACT

The invention relates to a method and apparatus for fast retrieval of frames of a video stream or other data fragments like sound for fast, non-real-time trickplay navigation through the content According to the invention, a group of multiple fragments of data is identified for rendering; the pick-up unit is moved to a location on the medium where the identified group of multiple fragments of data is stored; a fragment of data is selected from the group of multiple fragments of data, the fragment of data being fastest retrievable by the pick-up unit; and the selected fragment of data is retrieved for rendering.

The invention relates to a method of data retrieval from a medium by a pick-up unit for non-real-time rendering of data stored on the medium by rendering non-contiguous fragments of data.

The invention further relates to an apparatus for data retrieval from a medium, comprising means for receiving the medium, a pick-up unit for retrieving data from the medium for non-real-time rendering of data by rendering non-contiguous fragments of data, and a central processing unit.

The invention also relates to a consumer system for presentation of audio-visual data.

Furthermore, the invention relates to a record carrier comprising a computer program.

The invention also relates to a programmed computer.

Embodiments of such a method and apparatus can be found in U.S. Pat. No. 6,002,834. In a fast trickplay mode, only pre-determined, non-subsequent frames of a video stream stored on a disk are rendered. For each moment a frame has to be rendered in the fast trick-play mode, a table specifies the specific frame to be rendered.

Since specific, non-subsequent frames have to be rendered, a pick-up unit used to physically retrieve the data from the disk has to jump from a first location, where a first frame to be rendered is stored, to a second location where a second frame to be rendered is stored. This jump is made in at least two stages: a large jump to the location where the second frame is roughly located, followed by some fine-tuning. This takes quite some time.

It is an object of the invention to provide a method that is able to retrieve data for the trick play mode faster than methods known from the prior art.

According to the invention, this object is achieved in that the method comprises the steps of: identifying a group of multiple fragments of data for rendering; moving the pick-up unit to a location on the medium where the identified group of multiple fragments of data is stored; selecting from the group of multiple fragments of data the fragment of data being fastest retrievable by the pick-up unit; and retrieving the selected fragment of data for rendering.

An advantage of this method is that a fragment of data for rendering is retrieved much faster than with the method according to the prior art, because the pick-up unit does not have to be positioned exactly at the location of one fragment of data, but roughly in the neighbourhood of this fragment. From this neighbourhood, the fragment of data suitable for non-real-time rendering closest to the pick-up unit is retrieved. This saves time that is needed to accurately position the pick-up unit with respect to the position of one particular fragment of data.

Time-saving during retrieval provides a further advantage of the method according to the invention, because the time saved can be used to correct read errors by re-retrieving a fragment of data read erroneously.

An embodiment of the invention is characterized in that the method further comprises the step of increasing the number of fragments of data in the group as the rendering speed increases.

As the rendering speed increases, jumps made by the pick-up unit will be larger and, according to various methods known in the prior art, more fragments of data are rendered. The advantage of this embodiment is that the requirements of picking the correct fragment of data for rendering are lessened. This will hardly be noticed by a user.

The apparatus according to the invention is characterized in that the central processing unit is conceived to identify a group of multiple fragments of data for rendering; select a fragment of data from the group of multiple fragments of data, the fragment of data being closest to the pick-up unit; and retrieve the selected fragment of data for rendering.

The consumer system according to the invention is characterized in that it comprises the apparatus defined in claim 11.

The record carrier according to the invention is characterized in that the computer program stored on it enables a computer to perform the method defined in claim 1.

The programmed computer according to the invention is characterized in that the computer is able to perform the method defined in claim 1.

These and other advantages of the invention and embodiments thereof will be apparent from the description of the drawings, in which:

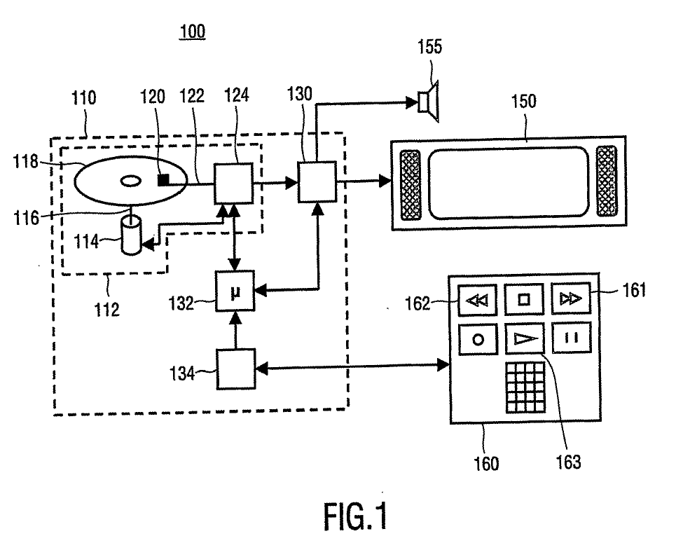

FIG. 1 shows an embodiment of the system according to the invention,

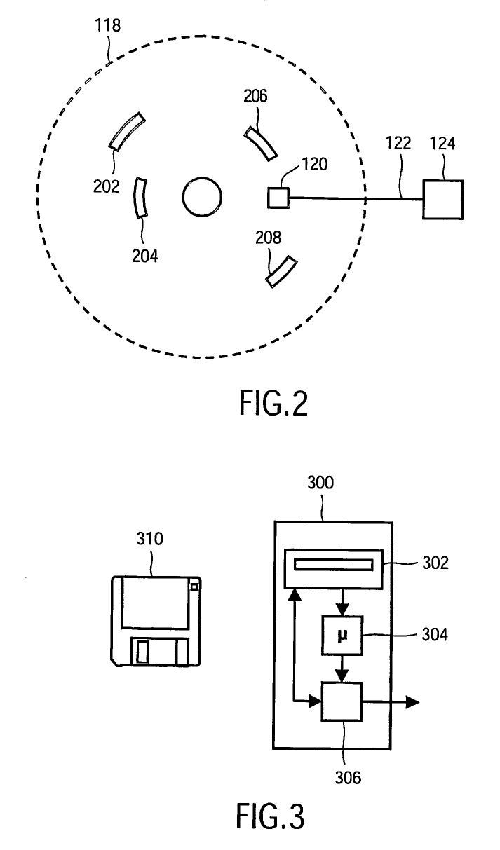

FIG. 2 shows a medium with a pick-up unit; and

FIG. 3 shows embodiments of the record carrier according to the invention and the programmed computer according to the invention.

FIG. 1 shows a consumer entertainment system 100. The consumer entertainment system 100 comprises an apparatus 110 as an embodiment of the apparatus according to the invention, a display device 150, a speaker 155 and a user input device 160. The apparatus 110 comprises a disk drive 112 comprising a motor 114 and a spindle 116 for spinning an optical disk 118 and a pick-up unit 120 on an arm 122 for moving the pick-up unit 120 across the surface of the optical disk 118. The disk drive 112 further comprises a local processor 124 for controlling movement of the arm 122 and for converting the raw data read from the optical disk 118 to a format that can be read by a rendering unit 130 which is also comprised in the apparatus 110. The apparatus further comprises a central processing unit 132 and a user input receiver 134. For reasons of clarity, only the relevant components of the apparatus 110 and the disk drive 112 are shown; a person skilled in the art will readily recognize that both will comprise many other components which are generally known to him.

The data format that is provided by the local processor 124 is preferably in a generic compressed data format like MPEG2 (Motion Pictures Expert Group) or MPEG1 layer 3 sound. As will be apparent to any person skilled in the art, also other data formats are applicable. The data in the compressed data format can be further processed by the rendering unit 130 to provide the display device 150 with a proper format for direct display, like a composite or RGB signal. The rendering unit 130 also converts the data from the local processor related to audio to a signal that is presentable by the speaker 155.

The user input receiver 134 receives signals from the user input device 160 and converts them to instructions for the central processing unit 132 which is adapted to control the components of the apparatus 110.

The user input device 160 comprises buttons enabling a user to navigate through content that is stored on the optical disk 118 while the content is being displayed on the display device 150. The user input device comprises a fast forward button 161 for scanning forward at a rate faster than real-time through the rendered content, a fast rewind button 162 for scanning backward at a rate faster than real-time through the rendered content, and a play button 163 for rendering the content in real time.

As mentioned, visual data to be rendered is preferably stored in MPEG2 format. MPEG2 is a compression technique relying on intra-frame compression and inter-frame compression. Intra-frame compressed (or intra-coded) frames can be decoded with information from the frame itself; for decoding inter-frame compressed (or inter-coded) frames, information from other (decoded) frames is necessary. However, the invention is not limited to retrieval of visual data compressed in accordance with the MPEG2 standard. Any type of data, compressed or not, can be retrieved using the method according to the invention.

For non-real-time fast rendering of video data, preferably only intra-frame-compressed frames are used, because such frames can be decoded much faster than decoding inter-frame-compressed frames. This is because only data from the frame itself is needed and no other frames have to be decoded. For high rendering speeds, this will not be of any problem to a user of the consumer entertainment system 100. For example, when video data will be rendered at a speed of 32 times real time, the number of intra-coded frames that could possibly be rendered in one second already exceeds the joint number of intra and inter-coded frames that is rendered in the real-time mode. In real time, frames are rendered at a speed of 24 frames per second, with two intra-coded frames per second, for this embodiment of the invention. Other real-time speeds are possible as well, such as 30 frames per second (NTSC) or 25 frames per second (PAL).

For non-real-time fast rendering of audio data, for example, acquired from a Super Audio Compact Disc or SACD, preferably bursts of audio are rendered in real time, the audio bursts forming a non-contiguous representation of the audio data as stored on the optical disk 118. The audio bursts are multiples of one audio frame, which covers 75 milliseconds of audio for SACD.

The way the data is stored on the optical disk 118 is optimized for rendering in real time. The data is stored on a spiral track (not shown) on the optical disk 118; when the data is read from the inside of the disk to the outside, along the spiral track, the data will be provided in real time to the local processor 124 and the rendering unit 132.

This means that the way data is stored is less optimal for fast trickplay of data, assuming that the disk can only be read at the speed at which the data is read in real time. This means that for data retrieval during fast trickplay, the pick-up unit 120 will have to be moved across the optical disk 180 from a first location, where a first intra-coded frame to be rendered is located, to a second location where a second intra-coded frame to be rendered is located. The pick-up unit 120 is moved by the arm 122, which movement is controlled by the local processor 124 controlling a servo (not shown) that moves the arm 122. Moving from the first location to the second location, the pick-up unit 120 actually ‘jumps’ from the first location to the second location. This jump is followed by fine-tuning of the position of the pick-up unit 120 by the servo. For this purpose, information in the spiral track is used.

For rendering video—but also audio—at high speed, the accuracy with which frame—or audio burst—is rendered is less relevant because the user will not notice the difference. With respect to video rendered at 32 times real-time speed, this means that it will not make any difference whether, after rendering a first frame, the next rendered frame is the 31^{st} or the 33^{rd}.

The actual fine-tuning of the position of the pick-up unit 112 takes time. Therefore, it would be advantageous if not exactly the correct frame—the 32^{nd} frame in the example described—would be picked up for rendering, but the frame that can be accessed fastest by the pick-up unit 112.

FIG. 2 shows the optical disk 118 with the pick-up unit 120, the arm 122 and the local processor 124 in more detail. FIG. 2 shows the position of the pick-up unit 120 after a jump, looking for the 32^{nd} intra-coded frame after the previous frame that has been rendered. In the stream stored on the optical disk 118, pointers are available on the whereabouts of the locations where the 32^{nd} intra-coded frame is stored.

FIG. 2 shows the locations of a first intra-coded frame 202, a second intra-coded frame 204, a third intra-coded frame 206 and a fourth intra-coded frame 208. The intra-coded frames in FIG. 2 are consecutive intra-coded frames. The second intra-coded frame 204 should be retrieved for rendering, since it is the 32^{nd} frame after the previous rendered frame. However, the third intra-coded frame 206 is closer to the pick-up unit 120 and can be retrieved fastest. Therefore, in the method according to the invention, the pick-up unit retrieves the third intra-coded frame for rendering.

It will be apparent to a person skilled in the art that the frame closest to the pick-up unit 112 will not necessarily be the fastest to be picked up. When a first frame is next to the pick-up unit 112 in a subsequent track and a second frame is located at a quarter turning from the pick-up unit 112, the second frame can be retrieved fastest, since it only takes a quarter turn to reach the start of the frame, whereas the retrieval of the first frame takes a whole turn to reach the start of the frame.

It will also be apparent to a person skilled in the art that, for proper functioning of the method according to the invention, the frame for rendering should be picked from a selected group of frames, in the vicinity of the actual frame that should be rendered to keep the desired fast trickplay speed. In one embodiment according to the invention, the group has a fixed size, like two consecutive frames in front of the frame to be rendered and two consecutive frames after the frame to be rendered. In a further embodiment, the fourth and second frames in front of and after the frame to be rendered are in the group of frames which are candidates to be retrieved for rendering. In yet a further embodiment of the method according to the invention, the size of the group can be determined by a user.

In again a further embodiment of the method according to the invention, the size of the group is determined by the speed at which audio-visual content is rendered. When audio-visual content is rendered at a high speed, the group from which an intra-coded frame for rendering can be selected is larger than when the content is rendered at a low speed. This is an advantage, because at a high speed such as 32 times real time, a user will not readily notice the difference between the rendering of a 30^{th} or 34^{th} frame. However, at 4 times real time, a user will surely notice the difference between showing a 2^{nd} or a 6^{th} frame after a first rendered frame.

It will be clear to a person skilled in the art that the same applies for fast trickplay of audio only. In that case, a group of audio ‘frames’ or bursts is selected and a burst comprised by said group closest to the pick-up unit is retrieved for rendering.

In a preferred embodiment, for proper control of the trickplay speed at, for example, 32 times real time, a location of a subsequent frame for rendering should be jumped to with reference to the frame that should have been rendered, instead of the frame that has actually been rendered. However, since a user will probably hardly notice or not notice the difference between rendering at 32 times or 31 times real time, this is not necessary for the invention, and according to another embodiment of the invention, the 32^{nd} frame after the actually rendered frame is selected to be rendered next.

The method can also be carried out on a general-purpose computer like the personal computer 300 as shown in FIG. 3. FIG. 3 also shows a data carrier 310 comprising data to program the personal computer 300 to perform the method according to the invention. To this end, the data carrier 310 is inserted into a disk drive 302 comprised in the personal computer 300. The disk drive 302 retrieves data from the data carrier 310 and transfers it to the microprocessor 304 to program the microprocessor 304. The programmed microprocessor 304 controls a media processor 306 to perform the method according to the invention upon retrieval of data from the disk drive 302 when rendering audio-visual data at high speeds.

Although the invention has been described with reference to embodiments that use an optical disk as a data carrier, it will be apparent to a person skilled in the art that the method according to the invention can be used to retrieve data from any data carrier from which data is retrieved, using a pick-up unit that is moved across the carrier or a pick-up unit with respect to which the data carrier is moved. According to a preferred embodiment of the invention, the memory is an optical disk carrying data in accordance with the Digital Versatile Disk standard. In another embodiment of the invention, the memory is an optical disk carrying data in accordance with the Super Audio Compact Disc standard. In yet another embodiment of the invention, the memory is a harddisk drive system. Although all embodiments mentioned relate to disk-shaped circular memories, the method according to the invention can also be applied to memories having a different shape, e.g. a rectangular shape.

In an embodiment of the invention, the group of data is not defined by a number of frames or audio bursts, but by a time interval. This time interval comprises several fragments as candidates for trickplay rendering of a stream stored on a carrier. These fragments may be frames, audio bursts or other kinds of groups of data. This embodiment, as various other embodiments of the invention, is applicable for audio data, video data as well a combination of both.

In summary, the invention relates to a method and apparatus for fast retrieval of frames of a video stream or other data fragments like sound for fast, non-real-time trickplay navigation through the content. According to the invention, a group of multiple fragments of data is identified for rendering; the pick-up unit is moved to a location on the medium where the identified group of multiple fragments of data is stored; a fragment of data is selected from the group of multiple fragments of data, the fragment of data being fastest retrievable by the pick-up unit; and the selected fragment of data is retrieved for rendering.

1. A method of data retrieval from a medium by a pick-up unit for non-real-time rendering of data stored on the medium by rendering non-contiguous fragments of data, characterized in that the method comprises the steps of:
identifying a group of multiple fragments of data for rendering;
moving the pick-up unit to a location on the medium where the identified group of multiple fragments of data is stored;
selecting a fragment of data from the group of multiple fragments of data, the fragment of data being fastest retrievable by the pick-up unit; and
retrieving the selected fragment of data for rendering.

2. A method as claimed in claim 1, wherein the data stored on the medium is a stream of audio-visual data.

3. A method as claimed in claim 1, wherein the data stored on the medium is a stream of audio data.

4. A method as claimed in claim 1, wherein the medium is a disk-based memory.

5. A method as claimed in claim 4, wherein the disk-based memory is an optical disk.

6. A method as claimed in claim 4, wherein the data is stored in accordance with the Super Audio Compact Disc standard.

7. A method as claimed in claim 4, wherein the data is stored in accordance with the Digital Versatile Disc standard.

8. A method as claimed in claim 2, wherein the group of multiple fragments is defined by a time interval.

9. A method as claimed in claim 3, wherein the group of multiple fragments is defined by a number of intra-coded video frames.

10. A method as claimed in claim 1, wherein the method further comprises the step of increasing the number of fragments of data in the group as the rendering speed increases.

11. An apparatus for data retrieval from a medium, comprising
means for receiving the medium;
a pick-up unit for retrieving data from the medium for non-real-time rendering of data by rendering non-contiguous fragments of data; and
a central processing unit,
characterized in that the central processing unit is conceived to:
identify a group of multiple fragments of data for rendering;
select a fragment of data from the group of multiple fragments of data, the fragment of data being closest to the pick-up unit; and
retrieve the selected fragment of data for rendering.

12. A consumer system for presentation of audio-visual data, comprising the apparatus as claimed in claim 11.

13. A record carrier comprising a computer program, characterized in that the computer program enables a computer to perform the method as claimed in claim 1.

14. A programmed computer, characterized in that the computer is able to perform the method as claimed in claim 1.
